(19) United States
(12) Patent Application Publication
(10) Pub. No.: US 2001/0056434 A1
(43) Pub. Date: Dec. 27, 2001

(54) Systems, methods and computer program products for managing multimedia content

(75) Inventors: Jon Kaplan, Naples, FL (US); Robert Protheroe, Naples, FL (US); Randy Martin, Naples, FL (US); David Riggle, Naples, FL (US); Juan Gonzales, Naples, FL (US)

Correspondence Address: R. Eric Gaum, Oldham & Oldham Co., L.P.A., Twin Oaks Estate, 1225 West Market Street, Akron, OH, 44313-7188, US

(73) Assignee: Smartdisk Corporation

(21) Appl. No.: 09/821,745

(22) Filed: Mar. 29, 2001

Related U.S. Application Data
(60) Provisional application No. 60/202,469, filed on May 8, 2000.
(60) Provisional application No. 60/200,096, filed on Apr. 27, 2000.

(51) Int. Cl. G06F 17/00; G06F 15/16

(52) U.S. Cl. 707/104.1; 709/219

(57) ABSTRACT

The present invention is a multimedia management system for storing, manipulating, and displaying multimedia content. The system comprises a user interface, a plurality of predefined functions, a multimedia acquisition interface, and system controls. The system provides users with a simple and intuitive method and computer program for reviewing multimedia content, which can include digital video, digital audio and text, still images, animation, and MIDI.

### TECHNICAL FIELD

The present invention relates generally to data processing systems, methods, and computer products, and more particularly to multimedia content and digital data processing systems, methods, and computer products.

### BACKGROUND OF THE INVENTION

The popularity of multimedia content is rapidly expanding on personal computers (PCs) and across the Internet. Today, the ability to stream or download multimedia content, such as movies and music, to a PC from the Internet is increasing daily. The number and types of computer program data files are also increasing. Currently, there are computer program file formats for digital video, digital audio and text, still images, animation and 3D, and MIDI (Musical Instrument Digital Interface). Several examples of such data files include JPEG (Joint Photographic Experts Group), GIF (Graphic Interchange Format), TIFF (Tag Image File Format), MOV, WAV, AVI (Audio Visual Interleaved), and MP3 (Moving Picture Exports Group 1, Audio Layer 3).

On the Internet today, PC users can access multimedia versions of television and cable network programs. Users can also stream or download movie or music trailers for popular movies and music videos. Due to advancements in PCs and related technology, users are also generating their own multimedia content at an astounding rate. Musicians use PCs to create digital music using MIDI. Writers and directors are filming and editing their own feature films on PCs using a variety of digital movie formats. Everyone from large corporations to individuals are creating their own web sites that incorporate any number of multimedia formats. As a result, it is becoming increasingly difficult for even the most technical individuals to keep track of and organize their computer files containing multimedia content.

### SUMMARY OF THE INVENTION

The present invention is a multimedia management system for storing, manipulating, and displaying multimedia content. The system comprises a user interface, a plurality of predefined functions, a multimedia acquisition interface, and system controls. The system provides users with a simple and intuitive method and computer program for reviewing multimedia content, which can include digital video, digital audio and text, still images, animation, and MIDI.

The multimedia management system includes a user interface that consists of a computer display having a primary set of options. In one preferred embodiment, the primary options include Desktop, My Computer, Favorites, History, and Catalog. The user interface presents all information and multimedia content through thumbnails, which are small image representations of larger images or content.

Another feature of the multimedia management system is called Play in Place. Users activate video and audio multimedia content directly within thumbnails thereby further simplifying previewing and selection of active multimedia content. A further feature of the present invention is called a Play List, which records the order that a user selects video and/or audio files and allows them to be played back in sequence.

The multimedia management system also includes a Rename and Copy function with a serialization option. Generally, the Rename and Copy function with the serialization option allows a user to designate a descriptive name for a series of digital images to be downloaded to a computer. The system will automatically renames each image with the descriptive name as it copies the image from a digital camera to a computer. A serial number is also added to the descriptive name to identify an entire series of images.

The present invention also includes powerful search capabilities for locating multimedia content on local personal computers, networks, Intranets and the Internet. The two primary search features include the use of customized tags added to HTML content and biometric recognition technology including but not limited to image, voice, music, and movie recognition.

Finally, an alternate preferred embodiment of the present invention combines the Play List and the accompanying multimedia content stored on high density removable media. A user connects the removable media to a computer or dedicated device. Once connected, an AutoPlay function automatically loads the multimedia management system, initiates the predetermined Play List, and then loads each selection of multimedia content in the predetermined sequence programmed by the user.

These along with other objects and advantages of the present invention will become more readily apparent from a reading of the detailed description taken in conjunction with the drawings and the claims.

### BRIEF DESCRIPTION OF THE DRAWINGS

FIG. 1 is a block diagrammatic depiction of one embodiment of the multimedia management system in accordance with the present invention;

FIG. 2 is a graphical representation of a user interface for the multimedia management system according to the invention;

FIG. 3 is a block diagrammatic depiction of one embodiment of control functions of the multimedia management system according to the invention;

FIG. 4 is a graphical representation of the control options available to a user via an interface;

FIG. 5 is a graphical representation of an interface depicting the Desktop primary option provided by the present invention;

FIG. 6 is a graphical representation of an interface depicting the My Computer primary option provided by the present invention;

FIG. 7 is a graphical representation of an interface depicting the Favorites primary option provided by the present invention;

FIG. 8 is a graphical representation of an interface depicting the History primary option provided by the present invention;

FIG. 9 is a graphical representation of an interface depicting one of the transparent pull down menus provided by the present invention;

FIG. 10 is a graphical representation of an interface depicting the Catalog primary option provided by the present invention;

FIG. 11 is another graphical representation of an interface depicting the Catalog primary option provided by the present invention;

FIG. 12 is a further graphical representation of an interface depicting the Catalog primary option provided by the present invention;

FIGS. 13A and 13B comprise a flow chart showing one embodiment of the computer program that implements the Play in Place function provided by the present invention;

FIG. 14 is a graphical representation of an interface depicting the shared Player Controls provided by the present invention;

FIG. 15 is a flow chart showing one embodiment of the computer program that implements the Play List function provided by the present invention;

FIG. 16 is a graphical representation of an interface depicting the Play List detailed information option provided by the present invention;

FIG. 17 is a graphical representation of an interface depicting the fall screen viewing option provided by the present invention;

FIG. 18 is a flow chart showing one embodiment of the computer program that implements the Rename and Copy function provided by the present invention;

FIG. 19 is a graphical representation of an interface depicting a plurality of digital images provided by the present invention;

FIG. 20 is a graphical representation of the user interface of the embodiment described in FIG. 18 depicting the Select Destination window provided by the present invention; and

FIG. 21 is a graphical representation of the user interface of the embodiment described in FIG. 18 depicting Rename and Copy window provided by the present invention;

FIG. 22 is a flow chart showing one embodiment of the computer program that implements the AutoPlay function provided by the present invention.

### DETAILED DESCRIPTION OF THE PREFERRED EMBODIMENT

The present invention is fully described hereinafter with reference to the drawings, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

A person of ordinary skill in the art would appreciate that the present invention may be embodied as a method, data processing system, or computer program product. As such, the present invention may take the form of an embodiment comprised entirely of hardware; an embodiment comprised entirely of software or an embodiment combining software and hardware aspects. In addition, the present invention may take the form of a computer program product on a computer-readable storage medium having computer-readable program code means embodied in the medium. Any suitable computer readable medium may be utilized including hard disks, flash memory cards, CD-ROMs, optical storage devices, or magnetic storage devices.

The present invention is described with reference to flowcharts and/or diagrams that illustrate methods, apparatus or systems and computer program product. It should be understood that each block of the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the flowcharts. The computer program instructions can also be stored in a computer-readable memory that directs a computer or other programmable data processing device to function in a particular manner, such that the instructions stored in the computer-readable memory produce an article of manufacture including instruction means which implement the function specified in the flowcharts or diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowcharts or diagrams.

It will be understood that blocks of the flowcharts support combinations of means for performing the specified functions, combinations of steps for performing the specified functions and program instruction means for performing the specified functions. It is also to be understood that each block of the flowcharts or diagrams, and combinations of blocks in the flowcharts or diagrams, can be implemented by special purpose hardware-based computer systems which perform the specified functions or steps, or combinations of special purpose hardware and computer instructions.

The present invention could be written in a number of computer languages including, but not limited to, C, C++, Basic, Visual Basic, Fortran, Cobol, Smalltalk, Java, and other conventional programming languages. It is to be understood that various computers and/or processors may be used to carry out the present invention without being limited to those described herein. The present invention can be implemented on an IBM or IBM-compatible personal computer, preferably utilizing a DOS, Windows 3.1, Windows 95, Windows 98, Windows NT, Unix, Linux or OS/2 operating system. The present invention could also be implemented on an Apple or Apple-compatible personal computer, preferably utilizing its own operating system. However, it should be understood that the present invention could be implemented using other computers and/or processors, including, but not limited to, mainframe computers and mini-computers.

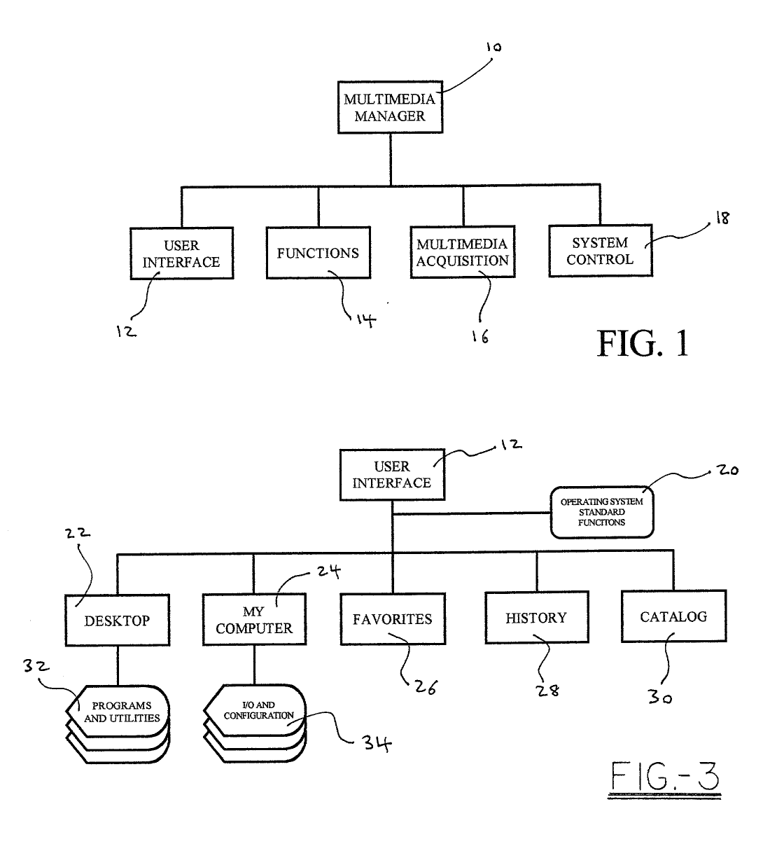

Referring now to FIG. 1, a block diagram of a preferred embodiment of a multimedia management system 10 for storing, manipulating, and displaying multimedia content in accordance with the present invention is shown. The system 10 comprises a user interface 12, a plurality of predefined functions 14, a multimedia acquisition interface 16, and system controls 18. The system 10 provides users with a simple and intuitive method and computer program for reviewing their multimedia content, which can include digital video, digital audio and text, still images, animation, and MIDI. The various types of multimedia content are typically in the form of digital computer file formats. Today there are dozens of multimedia file formats such as JPEG, GIF, TIFF, MOV, WAV, AVI, and MP3.

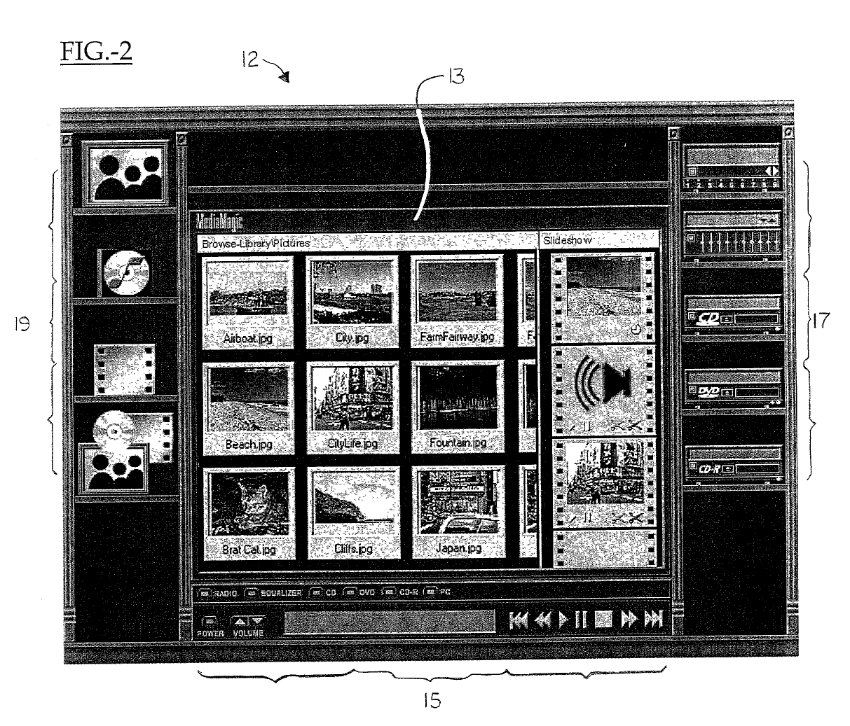

The multimedia management system 10 may include a user interface 12 as shown in FIG. 2. In the embodiment shown, the user interface 12 may comprise an entertainment center appearance with media displayed on a “monitor or TV” representation 13. The “monitor” 13 may be configured to have several viewing areas, such as to browse through the Library of still pictures shown on the left side of monitor representation 13, or to watch a slideshow or the like as shown on the right of the monitor 13. The interface 12 may also have control buttons 15, for controlling viewing and other options associated with the multimedia management system 10, as well as organizing and handling media and media presentations. There also may be representations of audio/video components 17, and representations of media types 19, which may be selected by the user. As seen in the interface shown in FIG. 2, the representations of audio/video components 17, and representations of media types 19 allow easy access to media in Libraries created by the user, with the multimedia data represented in thumbnails in the monitor representation 13.

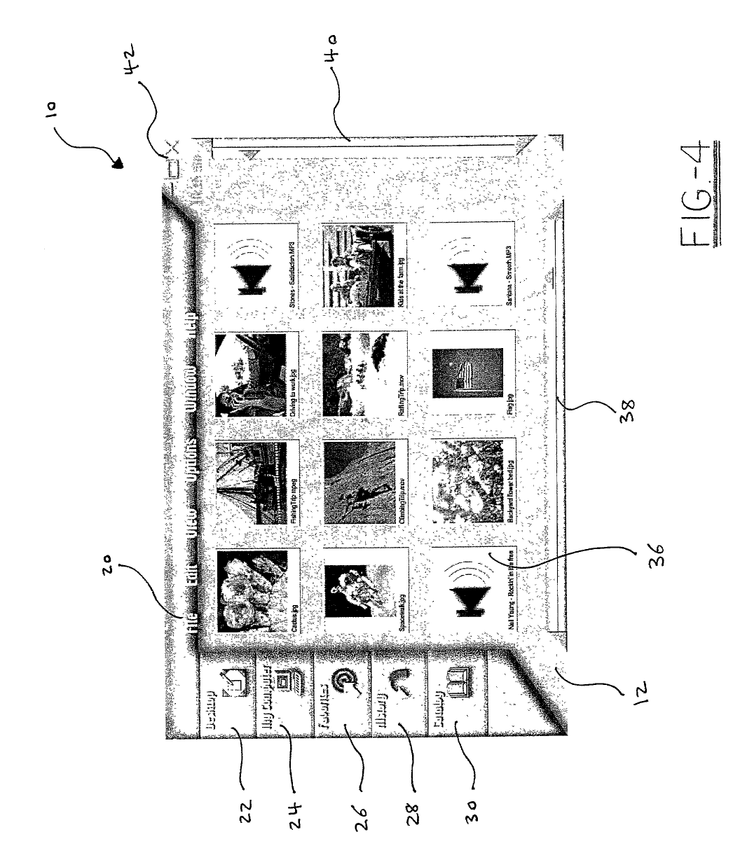

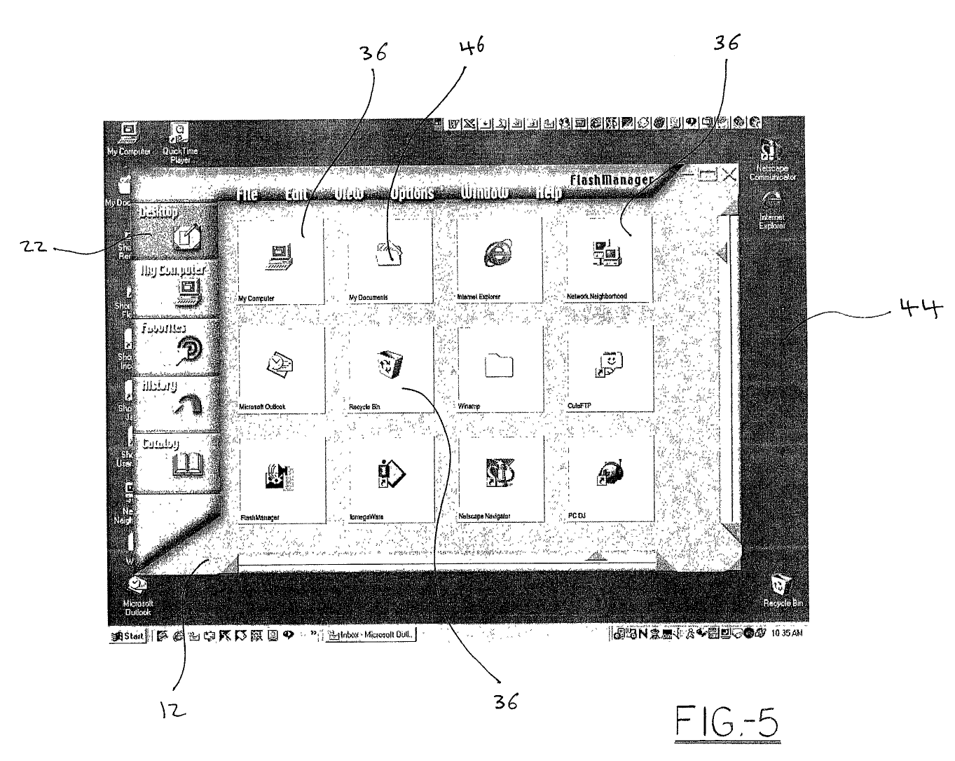

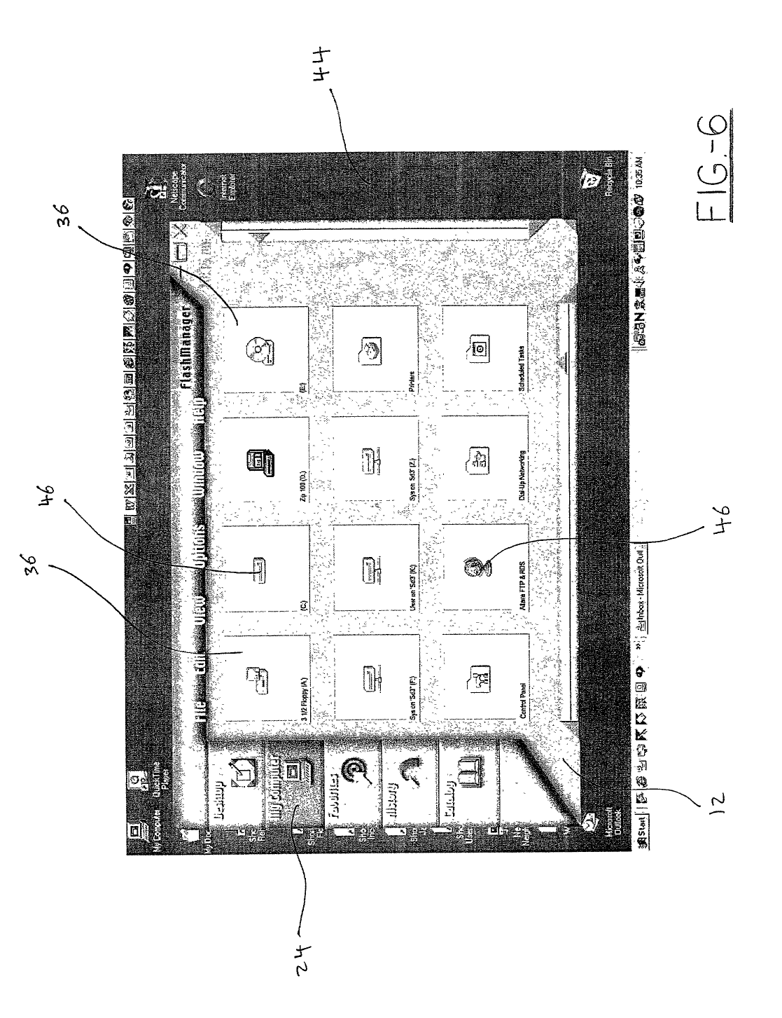

Referring to FIG. 3, the functions associated with the user interface 12 are shown. These functions may be carried out via control buttons provided in association with an interface such as shown in FIG. 2, or on a further interface accessed by the user, such as shown in FIG. 4. As seen in FIG. 3, a primary set of options may be provided via an interface to a user. In an embodiment, the primary options include Desktop 22, My Computer 24, Favorites 26, History 28, and Catalog 30. Each primary option may be represented on an interface as a “button.” To select one of the primary options, the user typically will move and click a mouse pointer over the desired button. Selection of the primary options is not limited to input via a mouse. Other means of activating the primary options include keyboard entry, direct contact by the user to a touch screen display, and voice recognition devices. Because the most popular PC operating system available today is Microsoft Windows, the interface for controlling functions of the multimedia management system may include operational options that correspond to common features of the Windows operating system. For instance, as shown in FIG. 5, the Desktop 22 button will display each of the icons 46 that are normally displayed by the Windows operating system on its desktop 44 or default display. One of the advantages to the user interface 12 of the present invention is that all information and multimedia content is displayed through thumbnails 36, which are small image representations of larger images. Generally, thumbnails 36 provide users with a more intuitive method of managing computer files, such as multimedia content, because users do not have to remember file names. The use of thumbnails 36 will subsequently be fully described. Other standard features of user interface 12 include horizontal and vertical screen scrolling actuators 38 and 40 respectively and control functions 42. The horizontal and vertical screen scrolling actuators 38 and 40 allow the user to scroll the display to view additional thumbnails 36 that would not otherwise fit on a single sized display. The control functions 42 emulate the standard control functions of the Windows operating system and allow the display to be closed, opened fully, or fully shrunken from the Windows desktop 44.

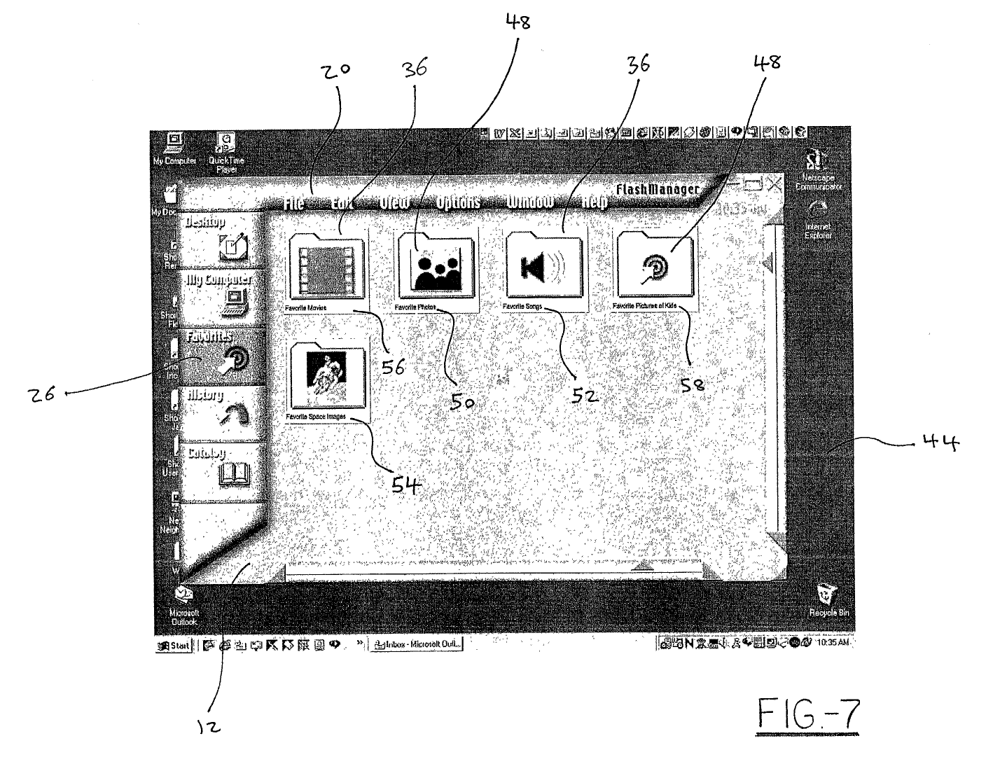

Referring to FIG. 6, the My Computer 24 primary option button displays a plurality of thumbnails 36 that each contain an icon 46 that corresponds to the icons normally associated with the My Computer option in the Windows operating system. Both the Desktop 22 and My Computer 24 primary options provide the user with access to standard functions available through the Windows operating system using the more intuitive thumbnail image interface. Not only does the graphical thumbnail interface make the user interface 12 easy to use, but by interfacing to the general Windows operating system commands, anyone familiar with the operating system will be instantly familiar with the user interface 12 of multimedia management system 10.

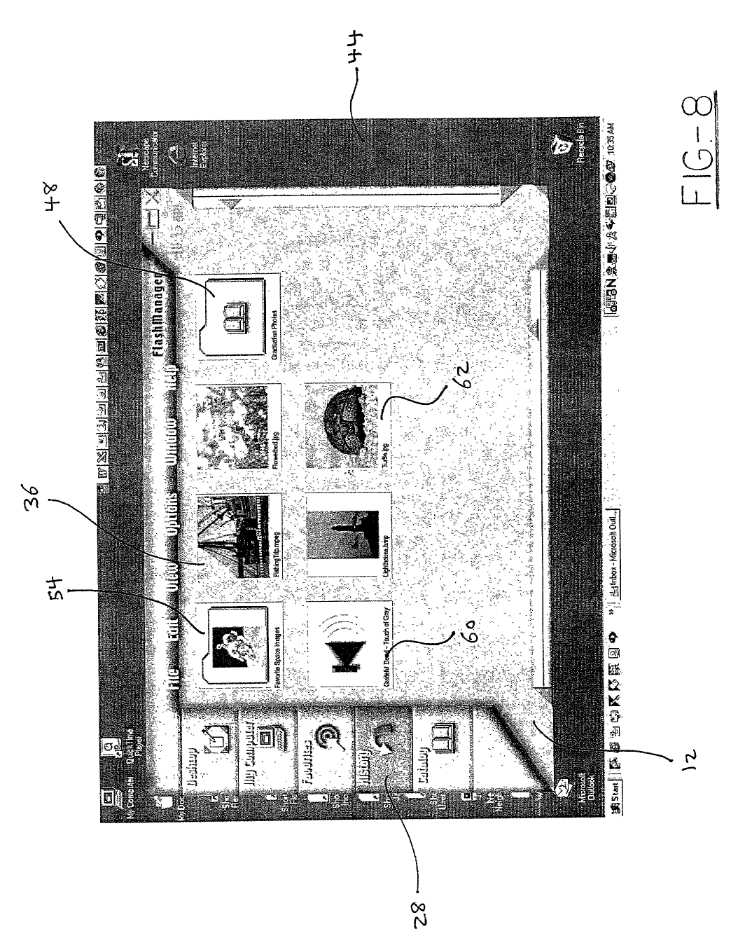

Referring now to FIG. 7, the Favorites 26 primary option button displays a plurality of thumbnails 36 that each represent and display a container 48. Essentially, containers 48 are graphical representations of the albums or entries in the multimedia database which point to the actual physical file in the computer system. Each container 48 includes a graphical representation displayed in a thumbnail 36 that allows users to identify the contents of the container 48 based upon the graphical representation or image displayed. The containers 48 displayed by the Favorites 26 primary option button allow users to store their favorite multimedia content in a convenient and quick to find location. Any number of containers 48 can be set up by the user to represent various types or categories of multimedia content. Once a container 48 is designated the user then assigns it an image that will appear in the thumbnail 36 for that container 48. The image assigned to the thumbnail 36 will be used to identify the contents of the particular container 48. In one preferred embodiment of the present invention, a series of default containers 48 are set up to hold types of multimedia content for movies 56, photos 50, and songs 52. Several examples of user designated categories of multimedia content include images of space 54 and pictures of kids 58. Users can store their favorite movies in the “movie” container 56, their favorite pictures of their children in the “pictures of kids” container 58, and so on. Once the user's favorite multimedia content is stored in the appropriate container, to access the multimedia content the user only has to use the mouse to click (hereinafter referred to only as “click”) on the Favorites 26 primary option button, then click on the appropriate container 48.

In association with organizing multimedia content, the multimedia management system may also allow the user to add a music track to the multimedia data to go along with the multimedia content when downloaded to removable media. The audio added to a multimedia data file could include multi track or surround sound capabilities, which would allow a great amount of flexibility in the types of audio information added to the multimedia content, such as voice and music. Thus, in addition to or apart from music, voice data may be added, allowing narration to be added to go along with a slideshow created from the multimedia content, which could then be downloaded to the CD as an example. The multimedia management system may allow narration to be added by a user when previewing the media presentation or slide show on the PC by means of a microphone connected to the PC. The multimedia management system could be configured to provide user selectable functions on the user interface when previewing a slide show, such as record and stop buttons to facilitate adding narration in association with current slides being viewed. The management system also allows audio files to be stored with other multimedia content, wherein the present invention would allow audio or other information to be automatically assigned across all media files in a folder when authoring a multimedia presentation.

To further assist the user, the multimedia management system 10 will prompt the user as to which container 48 a particular piece of multimedia should be stored. The user will normally store multimedia content in the various containers 48 using standard operating system functions 20, such as FILE, EDIT, VIEW, OPTIONS, WINDOW, and HELP. For example, the user may us the FILE function 20 to then copy a multimedia content file into one of the Favorites 26 containers 48. When the system 10 detects the user attempted to copy and/or move the file it will assist the user by asking which container to store the file within. The system 10 can also detect the type of file based upon its extension or other identifying characteristics. For example, if the system 10 detects a multimedia content file in the MP3 format, the system 10 will detect that the file contains music and either automatically store the file in the “songs” container 52 or suggest to the user that the file be stored in the “songs” container 52. Of course, the user is free to store the multimedia content file in any container 48 they wish. The management system provides a visual inventory of all multimedia content, whether on the PC or stored on external removable media, to facilitate retrieval of desired content from external removable media such as CD's, DVD's or removable disk drives. Content is indexed by the system for easy retrieval from such removable media or from the PC database by reference to a relevant index file to minimize the searching necessary to locate specific content. As an example, with the burgeoning use of digital cameras and digital video recorders, individuals are creating a voluminous amount of digital files stored on CD's or other external storage media, and any specific photograph or movie clip must be searched for throughout the user's collection of removable media. The present invention provides a completely seamless and integrated multimedia handling system is established. To facilitate the storage and subsequent retrieval of the multimedia data files, the multimedia management system user interface provides a plurality of predefined functions to uniquely index multimedia files, create an index database file, and create visual representations of the files for later retrieval. This function relates to a media library function of the media management system resident on a PC. The indexed file stores a pointer in the management system database to the physical file location, while providing a thumbnail image that can be used to represent the file in the management system user interface. This allows multiple pointers in the media management database, which relate to a single physical file stored on computer media. Thus, there is no need to store multiple physical files of the multimedia data, thereby saving storage space. Additionally, the media management system allows organization of the multimedia files into virtual albums of favorite multimedia files for easy access, while archiving the source material. The indexing system will automatically drop the indexing information into the library files for access.

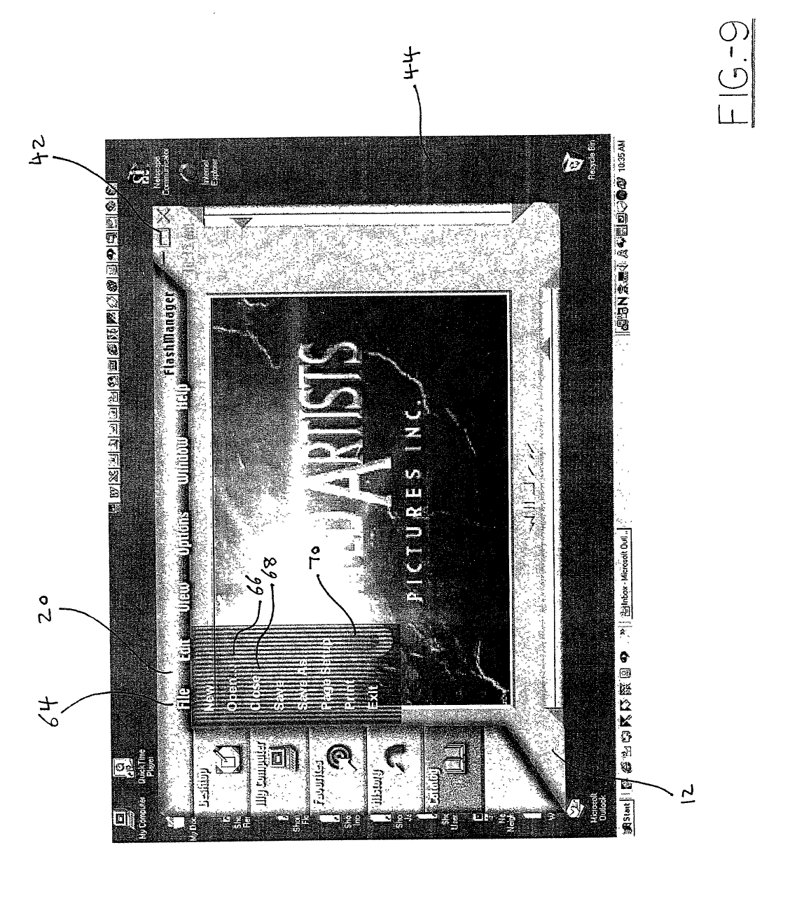

Referring to FIG. 8, the History 28 primary option button displays a predetermined number of thumbnails 36 that the user has recently accessed. If the user's most recent activity within the user interface 12 consists of viewing images in the “space” container 54, followed by listening to music 60, then followed by viewing a picture of a turtle 62, each of these thumbnails 36 will be displayed by the History 28 primary option button. This feature makes it simple for a user to access multimedia content that was most recently accessed.

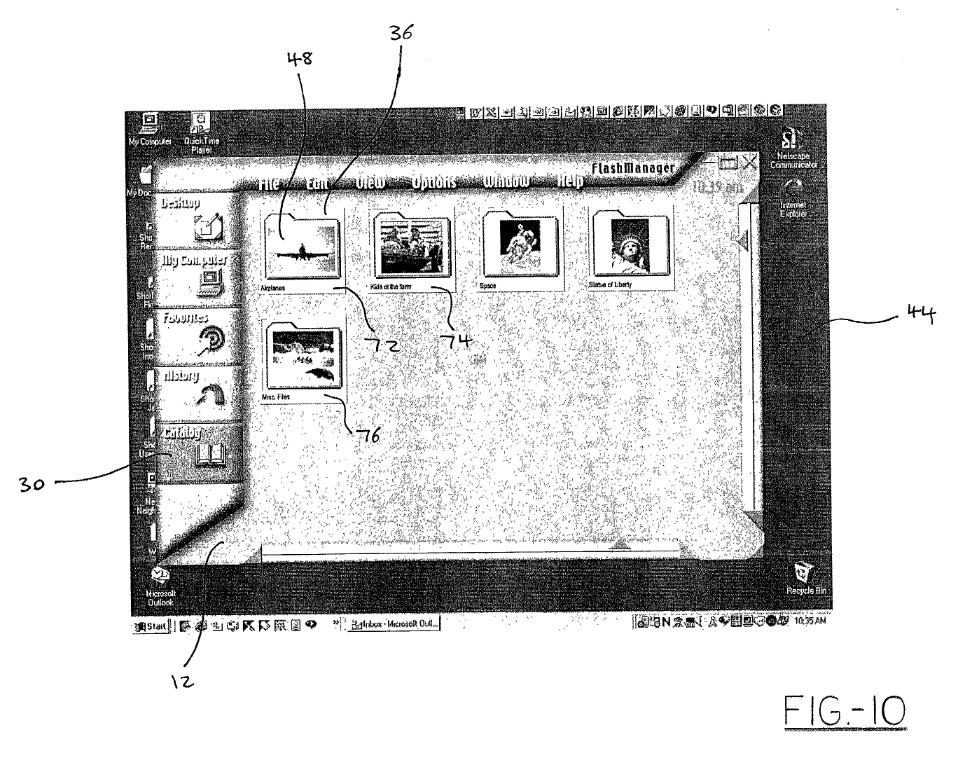

The Desktop 22, My Computer 24, Favorites 26, and History 28 primary option buttons are designed to make navigating through large amounts of multimedia content intuitive and simple for users. As discussed briefly above, to provide users with a familiar interface to the operating system, and in one preferred embodiment the Windows® operating system, a user interface 12 may include standard operating system functions 20, which consist of the following pull down menus: FILE, EDIT, VIEW, OPTIONS, WINDOW, and HELP. For example as shown in FIG. 9, if the user clicks on the FILE function 64, the pull down menu 70 containing a number of computer file operations such as OPEN 66 for open a file and CLOSE 68 for closing a file. So as not to block or disrupt the user's view of the thumbnails or multimedia content itself, the pull down menu 70 is see through or transparent. In one preferred embodiment of the pull down menu 70, any text or images behind the pull down menu 70 will show through allowing the user to access the standard operating system functions 20 while visually keeping track of the multimedia content displayed on the user interface 12.

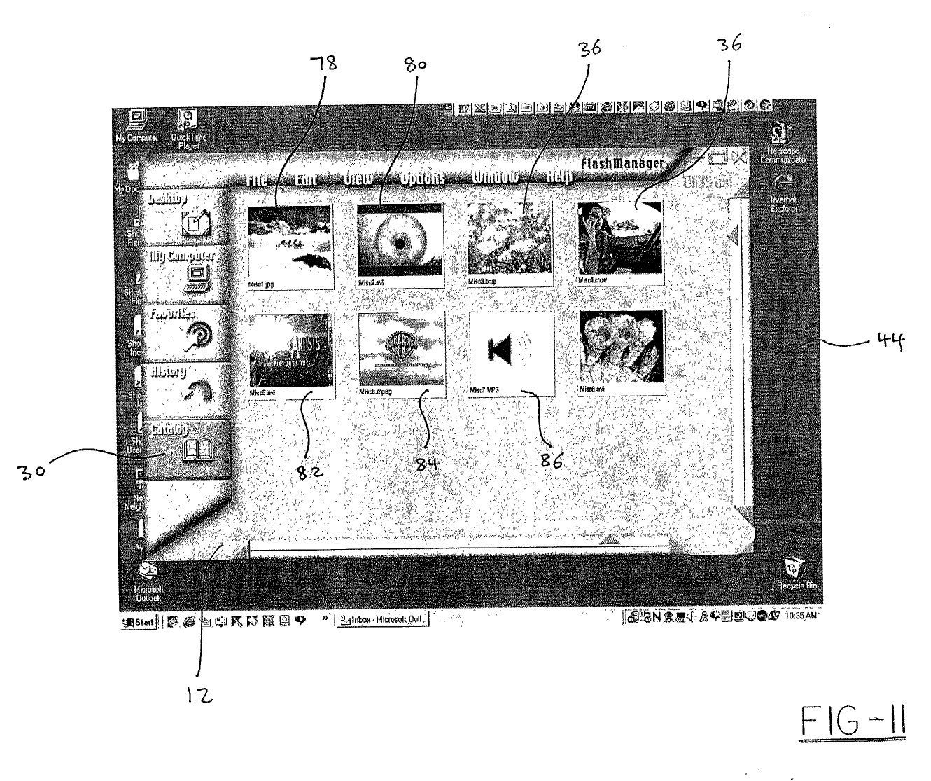

Turning to FIG. 10, the Catalog 30 primary option button displays a number of containers 48, which each include a thumbnail 36 that displays an image representative of the category of multimedia content stored by the user in the particular container 48. The thumbnails 36 allow users to easily determine what multimedia content is stored in which container 48, making accessing the multimedia content intuitive and simple for even the least technically inclined users. For example, the user can set up an “Airplanes” container 72 and a “Kids at the Farm” container 74. Within each container the user could store digital photographs, digital movie files, audio files and any other multimedia content related to either “Airplanes” or the “Kids at the Farm.” If the user clicks on one of the containers 48, for example the “Misc. Files” container 76, the user interface 12 displays the contents of that particular container 48.

In one preferred embodiment, to store multimedia content within a predetermined container 48, the user simply uses the “drag and drop” feature provided by the computer and mouse (not shown). A user positions the mouse pointer over the desired thumbnail 36 and then clicks and holds the left mouse button. While still holding the left mouse button the user drags the desired thumbnail 36 over the Catalog 30 primary option button by moving the mouse pointer over the same button. Once the thumbnail 36 has been positioned or dragged over the Catalog 30 primary button, the user releases the left mouse button or “drops” the thumbnail 36 on the button. By using the left mouse button, the multimedia management system 10 is instructed to create a new Catalog thumbnail container 48 for storing the multimedia content. If the same drag and drop sequence is performed using the right mouse button, the system 10 will prompt the user to select one of the current Catalog thumbnail containers 48 to store the multimedia content.

When the user decides to create a new multimedia content thumbnail 36 container 48 within the Catalog 30 primary option, the first thumbnail 36 image stored in the container 48 can be used on the container 48 to provide an indication of its contents. For example, if a new container 48 is created with pictures of airplanes, then the first thumbnail 36 picture of an airplane in the container 48 will be placed on the container 48 acting as that container's 48 icon. If desired, the user can also select a specific thumbnail 36 image and/or change the selected thumbnail 36 image at any time.

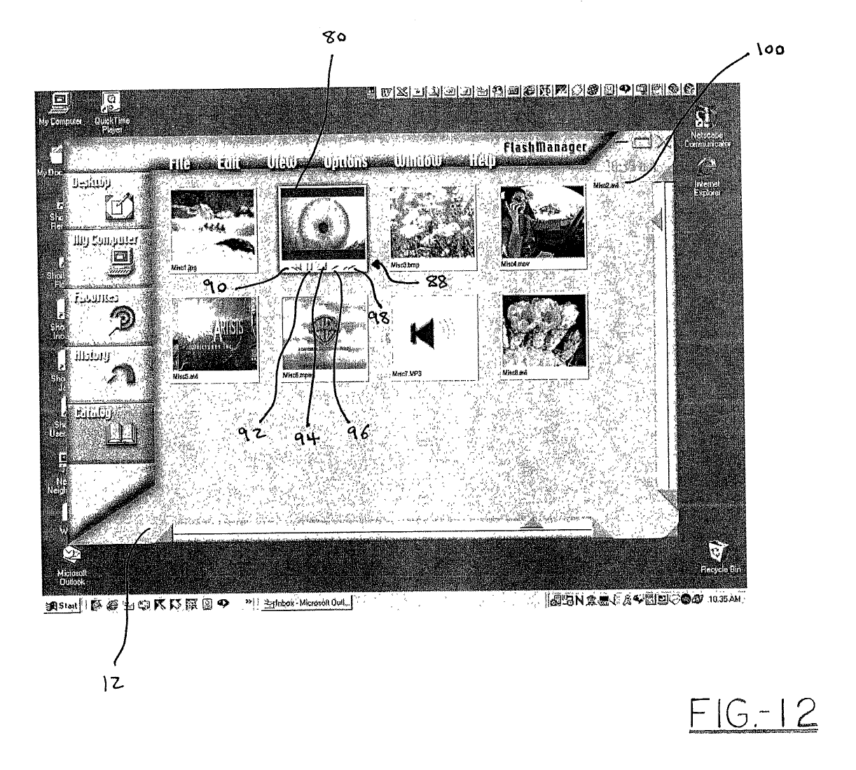

Referring to FIG. 11, the user interface 12 displays thumbnails 36 with images that identify the individual multimedia content computer files. For instance, thumbnail 78 is a JPG file meaning it is a digital image. The thumbnail 78 displays a small picture of the image showing white water rafters. All the user has to do is click on the thumbnail 78 image of the rafters to view the JPG image of the same picture. Additional thumbnails 36 display images, movies and music multimedia content. For example, thumbnails 80, 82, and 84 display images representing movies saved in the AVI and MPEG multimedia file formats. Thumbnail 86 displays an image representing an audio recording, which could include music, voice messages, dictation or any other form of audio content.

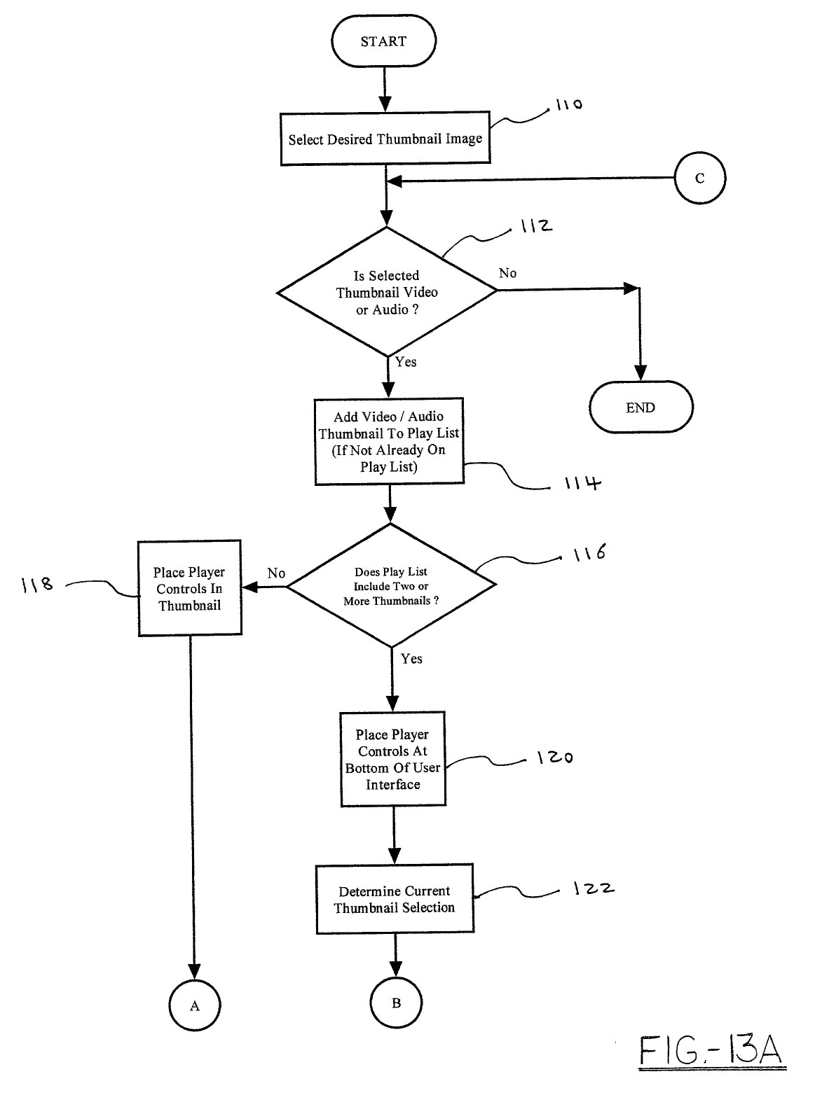

An additional feature of multimedia management system 10 allows users to play multimedia content, such as video and audio recordings, in place. In other words, users can activate video and audio multimedia content directly within the thumbnails 36 to further simplify previewing and selection of active multimedia content. This feature is generally referred to as “Play in Place.” Referring now to FIG. 12, when the user selects a movie or audio thumbnail 80 the multimedia management system 10 automatically places Player Controls 88 at the bottom of the thumbnail 80 to allow the user to preview the multimedia content within the thumbnail 80 or “in place.” In addition, the user interface 12 displays the computer file name 100 for the selected multimedia content. In a preferred embodiment, the Play Controls 88 include play 96, stop 94, pause 92, reverse 90, fast forward 98, and could further comprise other functions such as slow motion or the like. The Player Controls 88 are identical to standard functions found on common audio/video cassette recorders and/or CD/DVD players. The Play Controls 88 are shown at the bottom of the selected thumbnail 80 using standard symbols, also found on common audio/video cassette recorders and/or CD/DVD players. The Play Controls 88 allow the user to view the movie or audio multimedia content, stop or pause the content, forward or reverse the content, or the like. These functions allow users to easily preview video and audio multimedia content to quickly determine which content to play.

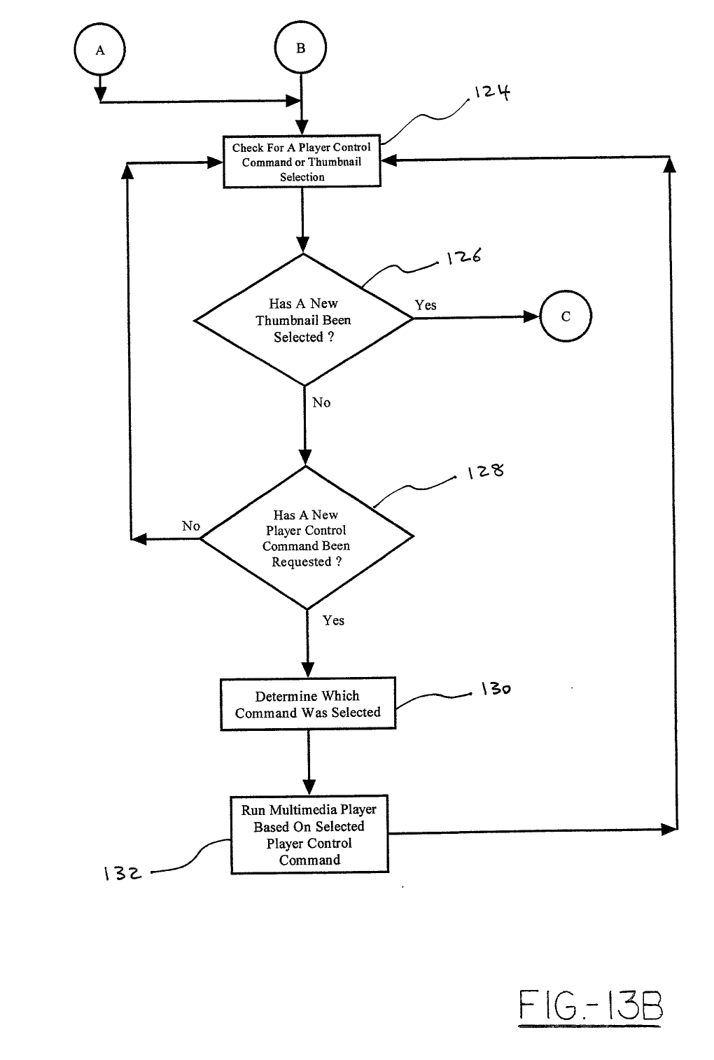

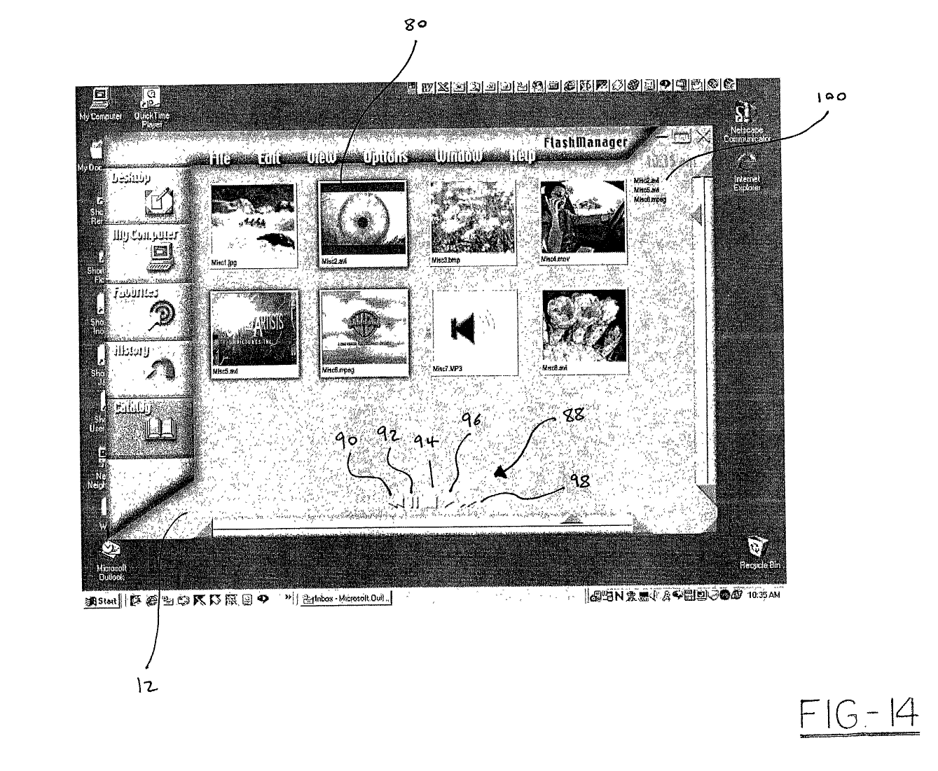

Referring now to FIGS. 13A and 13B, the Play in Place sequence of functions will now be described in further detail. The user first moves the mouse pointer over and clicks on a thumbnail with the mouse to select the desired thumbnail image 110. Once the user selects a thumbnail image the multimedia management system 10 checks to see if the thumbnail is a video or audio computer file 112. If the selected thumbnail is any format other than a video or audio file, such as a single image or document file, the Play in Place sequence of functions ends. If the selected thumbnail is a video or audio computer file, then the system 10 adds the file to the Play List 114. The Play List will be described in more detail later. For now, the Play List is represented by the file names 100 displayed along the right side of the user interface 12, shown in FIG. 14. If the selected video/audio computer file is already in the Play List then step 114 is not executed.

Next, the Play in Place function checks to see whether the Play List now has two or more thumbnail video/audio files listed 116. It should be noted that single images or other file formats could be added to the Play List if desired. This function will be described later. To simplify the description of the Play in Place function single images and other file formats will not be included at this time. If only one thumbnail is listed in the Play List then a set of Player Controls 88 is placed in the selected thumbnail itself 118. If the Play List contains more than one video/audio thumbnail, the multimedia management system 10 placed the Player Controls 88 directly on the user interface 12 near the bottom of the computer screen 120, as shown in FIG. 14. By placing the Player Controls 88 on the user interface 12 one set of controls can be used to operate whichever thumbnail is selected. This arrangement is more convenient for the user then if a separate set of Player Controls 88 was placed on each thumbnail, although such an arrangement could be configured in order to play multiple files at once. The system 10 then determines which thumbnail from the Play List (when there are multiple thumbnails) is currently selected 122.

At this point, whether the Play List only includes one thumbnail or several with one currently selected, the system 10 checks to see if a Player Control 88 command has been selected by the user or whether the user has selected a new thumbnail 124. If a new thumbnail has been selected 126 the system 10 then loops back and determines whether the newly selected thumbnail is a video, audio and/or still image computer file 112. If the user has not selected a new thumbnail then system 10 checks to see if the user has selected an initial or new Player control 88 command 128. If an initial or new command has not been selected the system 10 loops back and rechecks to see if a Player Control 88 command or a new thumbnail has been selected 124. If the user has selected a Player Control 88 command then the system 10 determines which command has been chosen 130, e.g., Play, Stop, Pause, Reverse, Fast Forward, or the like. The system 10 then runs the appropriate multimedia player based on the command chosen 132, thereby allowing the user to operate and preview the video, audio or still image selection. The multimedia players consist of computer programs and/or subroutines that play the multimedia file for viewing or listening by the user. One or more multimedia players are incorporated into the system 10 in order to run the multitude of multimedia computer file formats, e.g., MP3, WAV, MOV, AVI, etc. A person of ordinary skill in the art would be familiar with such multimedia players as they widely known and used on computers. In addition, it is contemplated that the present invention can accept multimedia players that developed for new multimedia computer file formats subsequently developed. Once the multimedia player has executed the selected command 132, the system 10 loops back and continues checking for new Player Control 88 commands or newly selected thumbnails 124.

It should be appreciated that although the flow charts of FIGS. 13A and 13B, as well as all flow charts of the present application, show the use of looping to implement various functions, a person of ordinary skill in the computer program arts would understand that the functions could be implement without looping. For example, each of the Player Control 88 commands could be interrupt driven based upon computer hardware and/or software inputs. In addition, any number of multitasking computer program methods could be used to provide the user with the various functions. The looping structures used in the various flow charts included herein are for convenience and not intended in any way to limit the scope of the present invention.

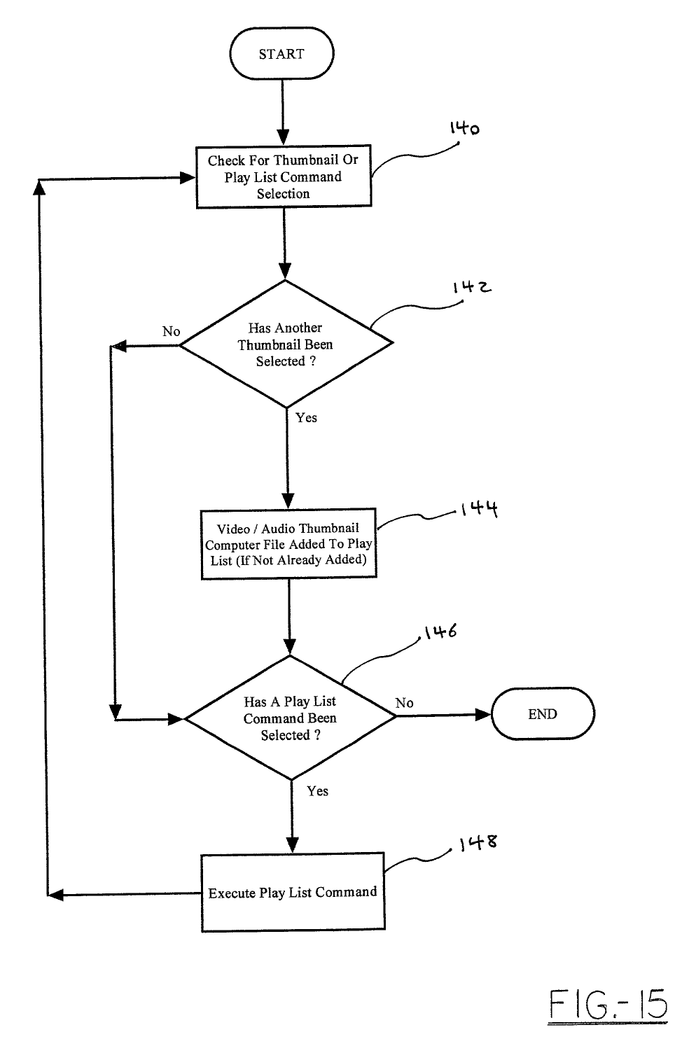

As previously mentioned, the Play List is represented by the file names 100 displayed along the right side of the user interface 12, shown in FIG. 12. The Play List is created as the user selects one or more thumbnails from the user interface 12. It does not matter where or in what container the user selects a particular thumbnail, it is automatically added to the Play List once selected. The user is able to select multiple video, still images and/or audio files to preview. The Play List records the order in which the user selects the video and/or audio files and allows them to be played back in sequence. Referring to FIG. 15, the Play List is created by the multimedia management system 10 by first checking to see if the user has selected a thumbnail or initiated a Play List command 140. If the user has selected a thumbnail 142 that is not already on the Play List, system 10 adds the thumbnail to the Play List 144. If no thumbnail has been selected 142, the system 10 checks to see if a Play List command has been selected 146. If no Play List command has been selected the computer program subroutine ends. If a Play List command has been selected 146, the command is executed 148 and the system 10 loops back and continues to check for a thumbnail or Play List command selection 140 by the user. The Play List commands are comprised of essentially the same functions as the Player Control 88 commands discussed previously.

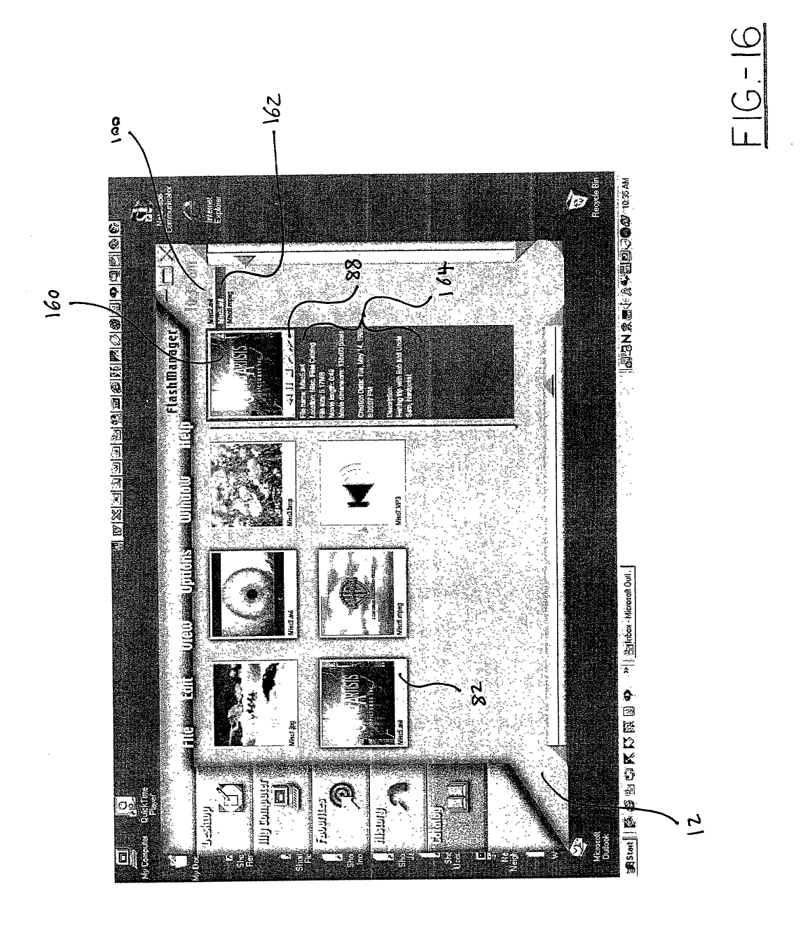

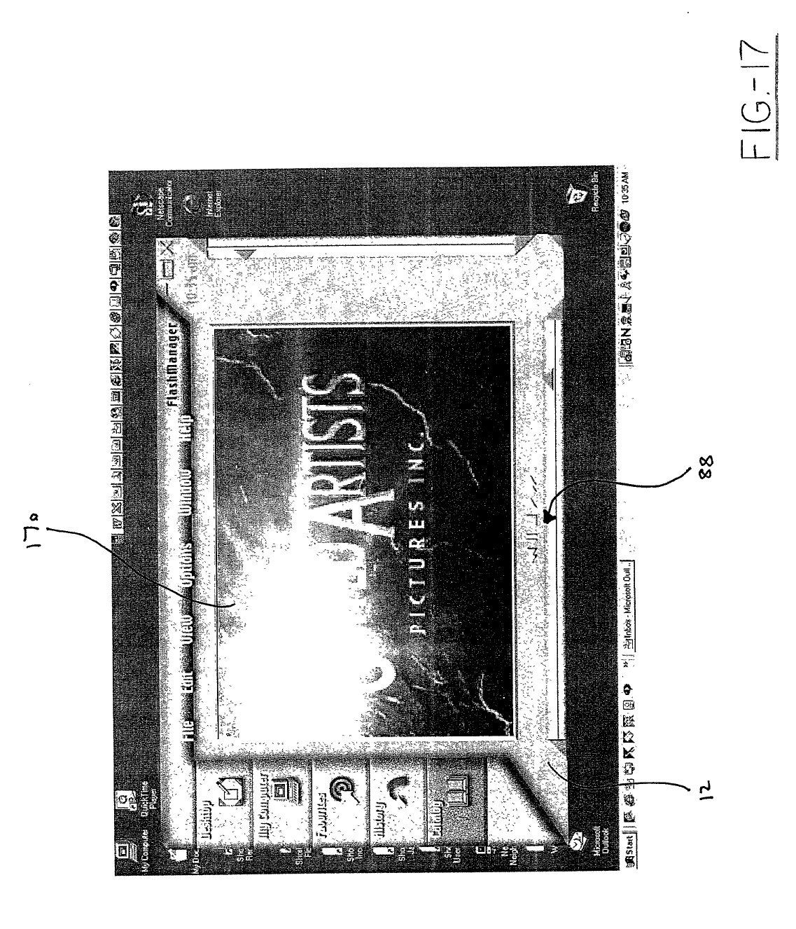

Although not described in detail, it should be noted that a variety of standard key sequences, including key sequences specific to the Windows operating system, can be used to select and/or deselect files from the Play List. A person of ordinary skill in the art would understand that the Play List could be manipulated in a number of different ways, including but not limited to deleting, rearranging, copying, pasting, and moving files on the Play List. One particular feature is the ability of the user to obtain detailed information and details regarding the contents of each thumbnail included in the Play List. Referring to FIG. 16, at any time a user can click on a multimedia computer file 162 included in the Play List and obtain detailed information 164, including but not limited to the file name, location of the file within the multimedia management system 10, the file size, the video length in minutes, the video dimensions, the date and time the file was created, and a brief description of the subject matter of the file. The user interface 12 also places an additional copy of the thumbnail 160 for the file selected from the Play List with the detailed information. For the convenience of the user, Player Controls 88 are included within the thumbnail 160, thereby allowing the user to preview the video/audio thumbnail selected while reviewing the detailed information. Another feature of user interface 12 is the ability to preview any selected video computer file in full screen mode. Referring to FIG. 17, the user interface 12 shows thumbnail 160 (from FIG. 16) expanded to fill a much larger portion of user interface 12, otherwise referred to as a full screen 170. As with previous embodiments, full screen 170 includes Player Controls 88 at the bottom of the screen to allow the user to preview the video file. The Play Controls 88 allow the user to view the movie or audio multimedia content, stop or pause the content, forward or reverse the content, or choose the next selection or previous selection. If desired, the user interface 12 could also be configured to provide optional full, three-quarter, half and other fractional screen sizes. To play a video file in a full screen 170, the user simply double clicks on the thumbnail containing the video file. The preferred embodiment of the multimedia management system 10 also includes a view option (not shown). The view option is selected from a pull down menu and allows the video file to be displayed within the entire computer screen, not just a full screen 170 within the user interface 12.

While many of the foregoing features of the multimedia management system 10 center around video and audio multimedia content, the present invention also provides a simple and efficient means for managing, organizing, and viewing single images such as digital photographs. These single images can include photographs or drawings that are digitized through common scanning techniques. In addition, the present invention is particularly well suited for use with digital cameras. Most digital cameras generate digital photograph computer files that can be directly downloaded to a computer. There are also a number of interface devices that allow video tape images to be digitized and downloaded to computers. The multimedia management system 10 manages and provides a simple and intuitive user interface through the use of thumbnails, as previously described in detail.

One problem encountered in downloading digital photographs is with the digital file naming conventions. Many digital cameras automatically label each image from 00 to 100 or with a similar consecutive numbering scheme. The problem with this numbering scheme is encountered when a user wishes to download a new set of digital images but has an existing set of images already stored on the computer. Because the digital camera keeps using the same numbering scheme of 00 through 100, if the user is not careful the previously stored images will be written over during the downloading of the new images. When the computer is controlled by the Windows operating system, the file will not automatically be written over but instead the user will repeatedly be prompted with a message asking if the user wants to write over the preexisting file. Either way, this can be a time consuming and frustrating problem. To overcome this problem, the multimedia management system 10 of the present invention includes a Rename and Copy function with a serialization option. Generally, the Rename and Copy function with the serialization option allows a user to designate a descriptive name for a series of digital images to be downloaded to a computer. The system 10 automatically renames each image with the descriptive name as it copies the image from the digital camera to the computer. A serial number is also added to the descriptive name to identify an entire series of images.

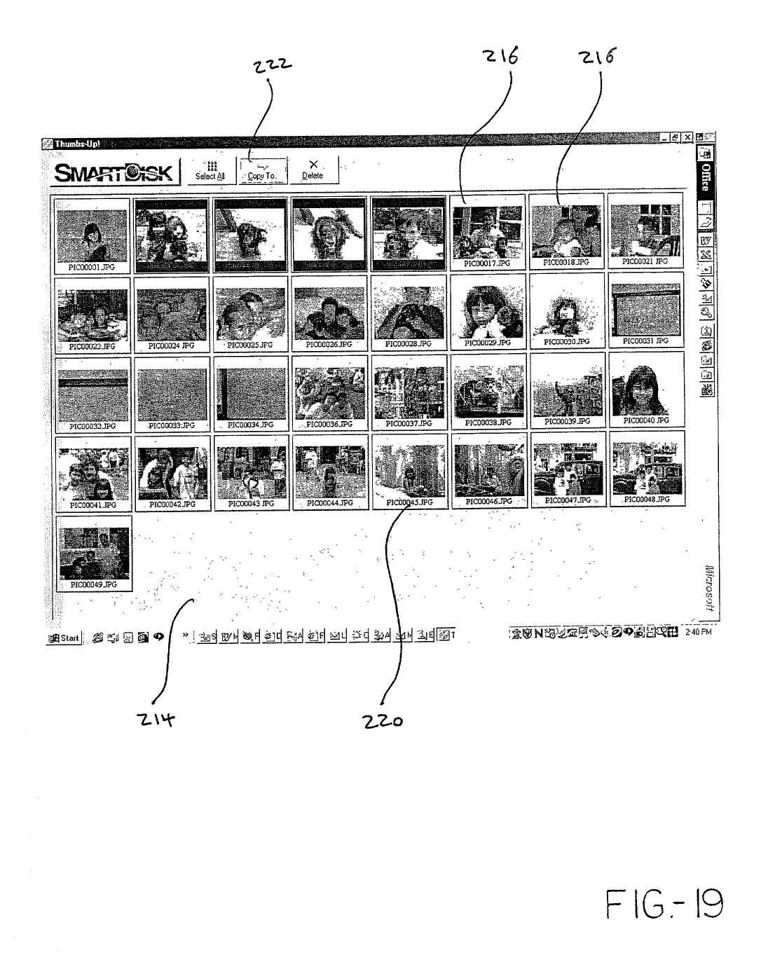

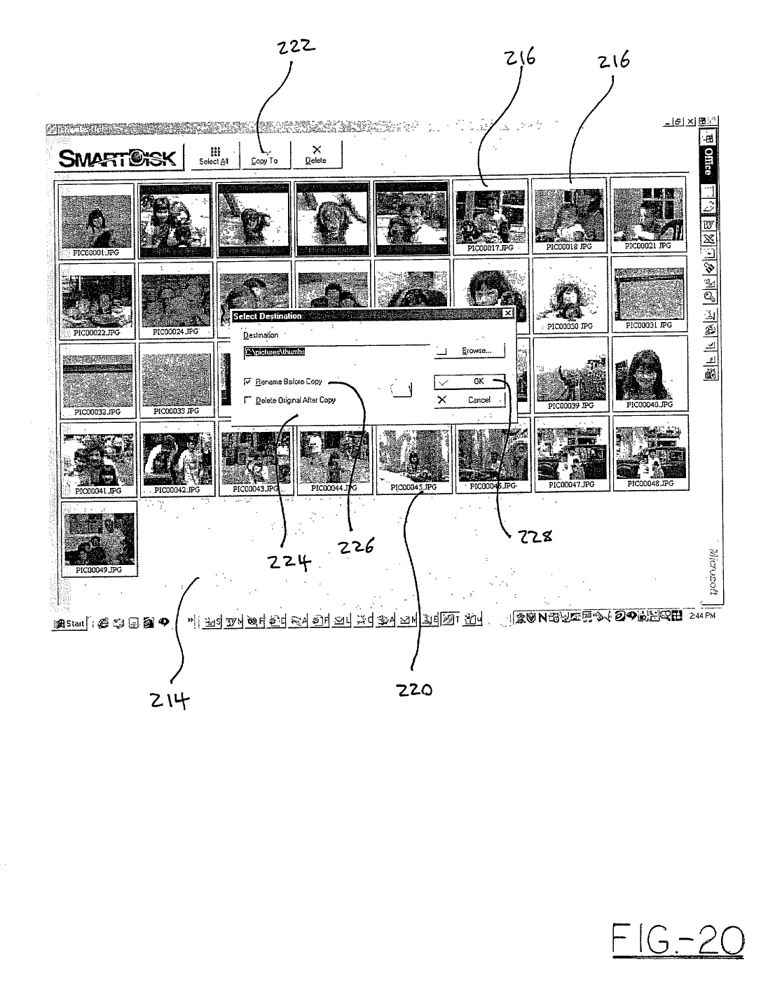

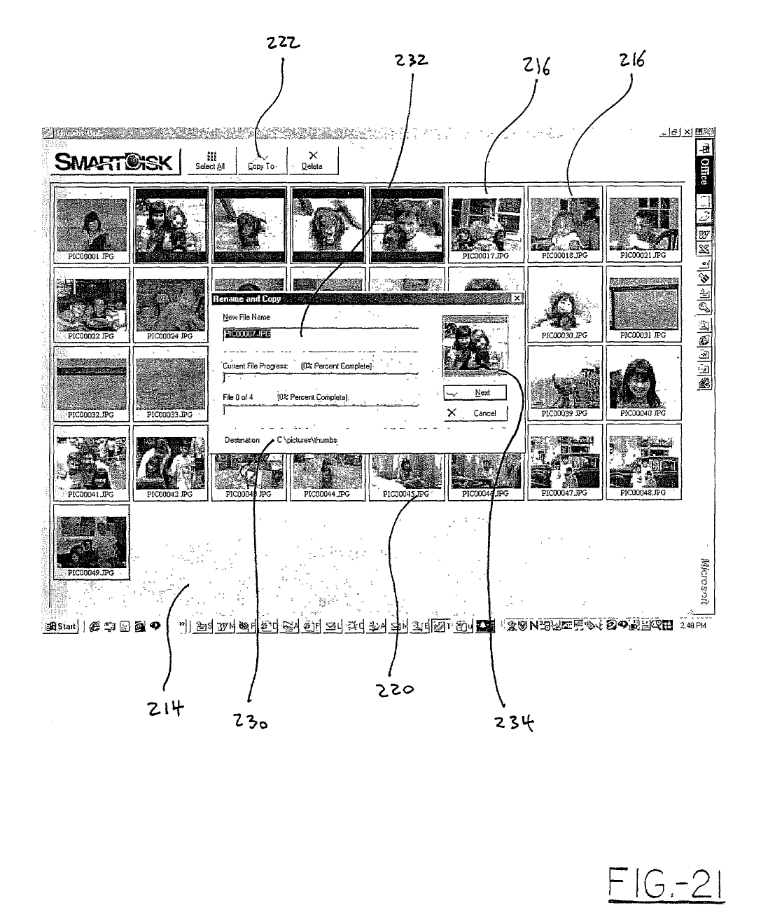

Referring generally to FIGS. 17-20, the Rename and Copy function with the serialization option will be described in more detail. FIG. 19 shows a computer screen 214 with a series of digital image thumbnails 216 displayed, each containing an individualized file name 220. The individualized file names 220 are the default file names assigned by the digital camera, e.g., PIC00017.JPG, PIC00018.JPG, PIC00019.JPG, etc. To copy the digital images represented by the thumbnails 216 to the computer, the user simply clicks on the Copy To 222 button. In response to this selection, the multimedia management system 10 prompts the user with a Select Destination window 224, shown in FIG. 20, which allows the user to determine where on the computer the digital images will be stored. Within the Select Destination window 224 the user has the option of requesting the Rename Before Copy 226 option. If the user selects this option the Rename and Copy function will be automatically initiated once the user clicks on the OK button 228 within the Select Destination window 224. The user is next prompted with the Rename and Copy window 230, shown in FIG. 21, which displays a thumbnail image 234 of the selected digital image and prompts the user to provide a new file name 232 for the image.

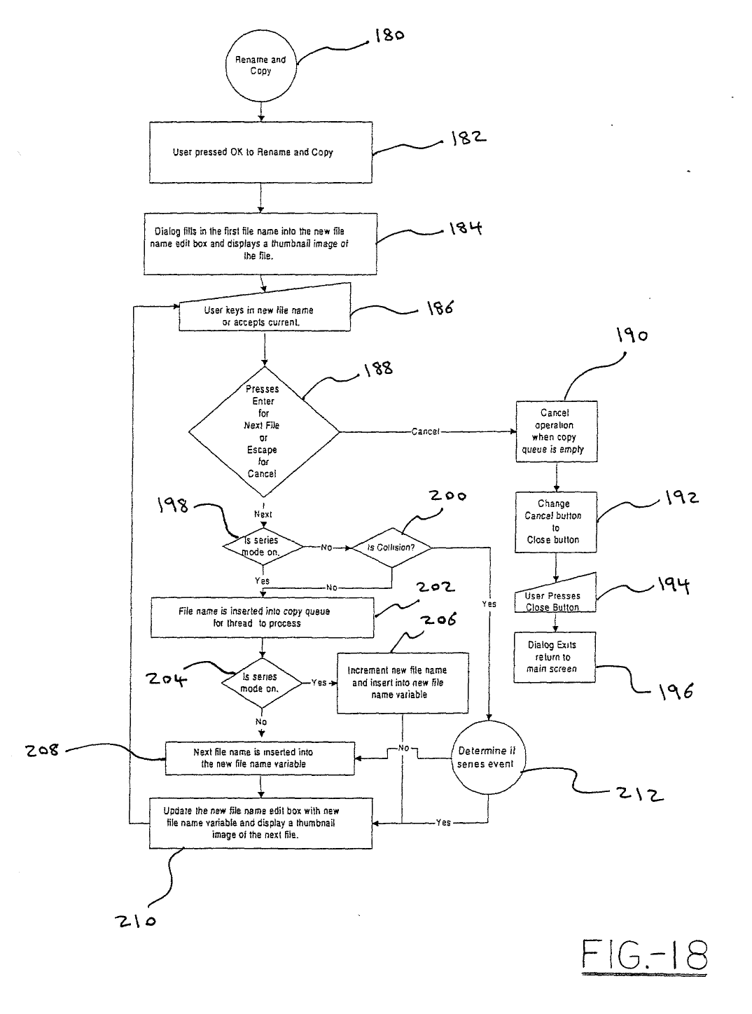

Referring more specifically to FIG. 18, the Rename and Copy 180 computer program or subroutine begins by checking to see if the user pressed “OK” or selected the Rename and Copy function 182. The dialog box then fills in the first file name within the new file name edit box and displays a thumbnail image of the file 184. At this point, as described generally above, the user enters or keys in a new file name for the digital image or accepts the currently assigned (default) name 186. The Rename and Copy 180 program then checks to see whether the user pressed/clicked the Enter key to move on to the next digital image or whether the Escape key was pressed in order to cancel any further digital image copying 188. If the Escape key is selected, all further copying operations are canceled after the copy queue for the preceding digital image is empty 190. Next, the dialog box or window (not shown) changes the Cancel button to a Close button 192. The user can then select the Close button 194 and the dialog box or window will exit and the computer program will return to the main screen 196.

If the user selects the Enter key 188 then the computer program checks to see if the series or serialization option is turned on 198. If the series option is not turned on then the computer program checks to see if the collision option is on 200. The collision option 200 is used to detect and prevent two digital images from being assigned the same file name, which would cause one file to be written over the preexisting file having the same name. For example, if the preexisting digital image file name is “granddaughter playing in park 1” and then another file has the same name, the two files will collide with each other. If the collision option 200 is enabled, the computer program will automatically prompt the user as to whether or not to assign the second file the name “granddaughter playing in park 2.”

If the serialization option is enabled 198 or the serialization option is disabled 198 and the collision option 200 is disabled, the computer program then inserts the file name assigned to the digital image in step 186 into the copy queue for further processing 202, i.e., copying of the file under the file name assigned to the computer. At that point the computer program again checks to see if the serialization option or series mode is enabled 204. If it is, then the new file name is incremented and inserted into a new file name variable 206. The new file name edit box is then updated with the new file name variable along with a thumbnail of the next digital image about to be assigned the new file name variable 210. The computer program then loops back and the user is then prompted to key in a new file name or accept the currently assigned file name 186.

If the serialization option (serial mode) is not enabled 198 and the collision option is enabled 200, then the computer program determines whether there is a series event 212, meaning whether or not the current file name for the digital image needs to be incremented or changed to avoid a collision. If not, the computer program inserts the current file name into the new file name variable 208 and then the new file name variable edit box is updated with the current file name and displayed with a thumbnail of the next digital image. The computer program then loops back and prompts the user to enter a new file name or accept the currently assigned name 186. If the computer program determines that a series event has occurred 212, the edit box is updated with a new file name variable and again displayed with a thumbnail of the next digital image 210.

The multimedia management system 10 of the present invention also includes powerful search capabilities for locating multimedia content on local personal computers, networks, Intranets and the Internet. The two primary search features include the use of customized tags added to HTML content and biometric recognition technology.

The first methodology entails adding specialized tags to the HTML content of web pages on Intranets and the Internet. Each tag is specifically designed to be located and parsed by the multimedia management system 10 of the present invention. For example, specific tags could include information that would instruct the system 10 as to whether a particular piece of multimedia content was a picture, what the subject of the picture is, the size of the multimedia computer file, or any number of other useful pieces of information. In addition, tags could include Keywords that allow the system 10 to recognize the multimedia content as belonging to a specific type of content. For example, a Keyword might be the word “bird” and all multimedia content that is tagged with the same Keyword is automatically recognized as in some way being related to birds. This would be true whether the multimedia content was a photograph of a bird, an advertisement for bird food, or a recipe for chicken. The Keywords use the content to drive the search as opposed to just the Keyword itself. The only drawback to the tag methodology is that it requires third parties to incorporate information specific to the multimedia management system 10 within their Intranets and Internet web pages or other multimedia content. Despite this potential drawback, the use of custom tags provides an extremely powerful methodology of searching for multimedia content.

The second search methodology incorporated within one preferred embodiment of the present invention uses biometric technology, which matches unique image characteristics in order to locate information. For example, the key characteristics of a celebrity's face could be analyzed and labeled with the celebrity's name. To find images of the celebrity on the Internet or other computer or networks, the searching computer program would analyze images until a match of the facial characteristics is found. Biometric matching is a widely used technology for identifying individuals, particularly for security reasons. Biometrics is the statistical study of biological information such but not limited to iris or retina patterns, facial characteristics, fingerprints, hand shapes, hand writing characteristics, writing or linguistic styles, or voice patterns. The system 10 of the present invention incorporates known methods of biometric matching including but not limited to picture recognition, voice recognition, music recognition, and movie recognition. Biometric matching and searching methods currently exist as shown in U.S. Pat. No. 6,047,282 for an Apparatus and Method for Expandable Biometric Searching, a copy of which is attached to this application and incorporated herein by reference.

Although the foregoing description of the multimedia management system 10 of the present invention is primarily targeted for use with personal computers, either alone or connected to various types of local or international networks, the system 10 can be used with or incorporated into any number of devices. For example, such devices include but are not limited to hand-held computers, dedicated computers, video games, mobile communications equipment, or incorporated within television sets, home audio equipment and car stereos.

One example of an alternate application for the present invention is in the use of high definition television (HDTV). One or more HDTV sets could incorporate the multimedia management system 10 directly within themselves or the HDTV sets could be network together by a computer network. Using the Play List feature of system 10, the user could designate what multimedia content is played on which HTDV set (or a regular television set for that matter) within a home or office. This would allow, for example, a user to provide children's television programming in one room, viewing of the latest movie in another room, and music playing in a third room. The same type of arrangement can be implemented within an automobile. The system 10 could run multimedia content from the Play List to allow one type of music to be played in the front seat of the automobile, while a movie is played in the back seat to entertain children or other passengers.

In an alternate preferred embodiment of the present invention, the Play List and the accompanying multimedia content are stored on high density removable media, including but not limited to CD-ROMs and large, portable hard drives. Currently existing multi gigabyte, portable hard drives manufactured by Smartdisk Corporation are ideally suited for storing Play Lists and the related multimedia content. A user simply connects the portable hard drive to a computer or dedicated device, i.e., a device such as a HDTV set with a hard drive port including but not limited to a USB, USB20, or FireWire port, and lets an AutoPlay function operate the multimedia management system 10 incorporated within the portable hard drive. The portable hard drive or other removable media also includes any computer programs necessary to run or view the multimedia content stored on the hard drive. Once the portable hard drive is connected to a computer or dedicated device, the AutoPlay function automatically loads the multimedia management system 10, initiates the predetermined Play List, and then loads each selection of multimedia content in the predetermined sequence programmed by the user. An entire evening of multimedia content can be stored and operated automatically through a portable, removable media.

It is also contemplated that a manufacturer could preprogram the portable, removable media so that users could purchase entire sets or Play Lists of predetermined multimedia content. For example, one preprogrammed portable, removable media could have a disco theme for use at parties. The removable media could be programmed with disco music, the movie Saturday Night Fever, and a number of still images of people dancing. Of course the number and variety of preprogrammed multimedia content is only limited by ones imagination. Rather than purchasing entirely new portable, removable media such as hard drives, users could also purchase preprogrammed multimedia content over the Internet or through kiosks located in shopping malls or stores and have their preexisting portable, removable media reprogrammed. The user could also store multiple preprogrammed multimedia content on a personal computer and simply select which preprogrammed content to place on their portable, removable media.

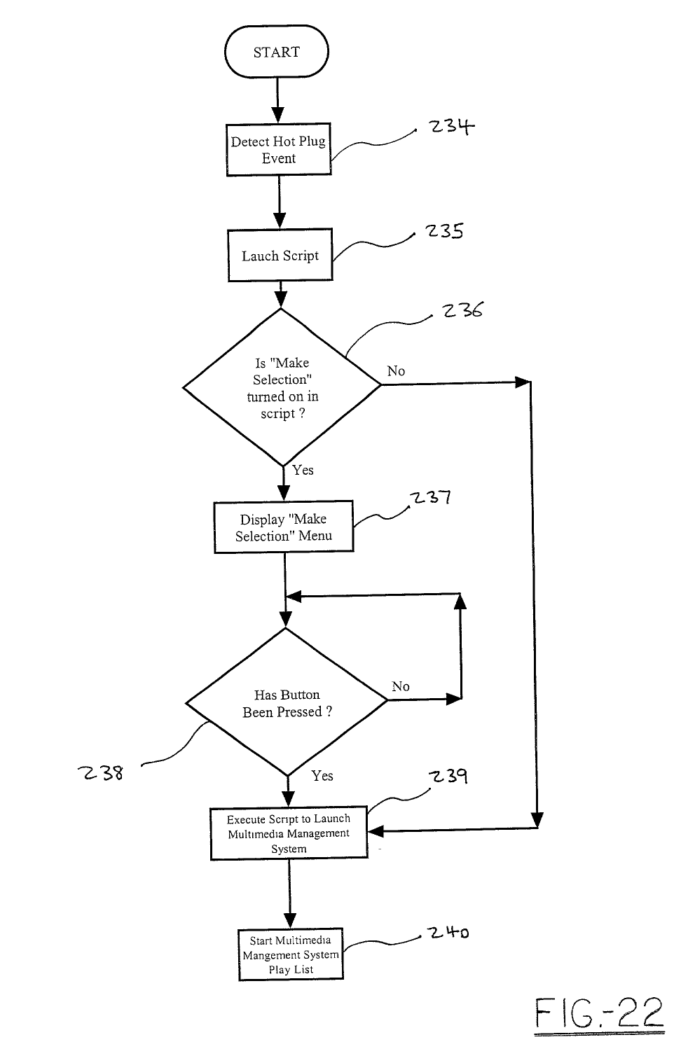

FIG. 22 is a flow chart showing the AutoPlay feature. The AutoPlay software waits for notification of a device being hot plugged into the computer 234 (e.g., plugging a fire wire hard drive into the computer). When the hot plug event is detected the AutoPlay software automatically searches for a multimedia management system script file and executes the commands in the script file 235. If user input is required by the script 236, then the user is prompted to make a selection 237 using the mouse or keyboard 238. Next, the AutoPlay software starts executing the multimedia management system 10 commands 239. One use for the AutoPlay feature is to automatically start the multimedia management system 10 Play List 240.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

What is claimed is:

1. A system for managing a multimedia data files comprising:
a user interface providing control functions which are selectable by a user,
a representation of the multimedia files selectively viewable in association with the user interface, wherein the representation comprises an image representing the data file and a pointer to the multimedia data file accessible in a computer readable memory device, and
a system for displaying the multimedia data file in association with the representation on the user interface.

2. The system according to claim 1, further comprising controls provided in association with the user interface for selective control of display functions associated with the display of the multimedia data file in association with the representation.

3. The system according to claim 2, wherein the controls are selected from the group consisting essentially of play, stop, pause, reverse, previous selection, next selection and fast forward functions.

4. The system according to claim 1, wherein the multimedia data files are selected from the group consisting essentially of still images, video, audio or combinations thereof.

5. The system according to claim 2, wherein the controls are associated with a representation of a multimedia data file.

6. The system according to claim 2, wherein the controls are positioned in association with the user interface and not at particular representation of a multimedia data file, wherein the controls will operate to control display of a multimedia data file which has been highlighted on the user interface.

7. The method for managing multimedia data files comprising the steps of:
storing a multimedia data file in a data storage system,
creating a representation of the multimedia data file in a user interface in association with a media display system, and
playing the multimedia data file in association with the representation upon selection of the representation on the user interface.

8. A multimedia data management system comprising:
at least one multimedia data file stored on a storage system, the file designated with at least a first name,
a computer program having instructions to copy a selected multimedia data file and store the data file in a database, and
a computer program selectively implemented by a user for renaming the data file with a second name prior to storage in the database.

9. The data management system according to claim 8, wherein the computer program further promotes the user to select a destination for the multimedia data file stored in the database.

10. The data management system according to claim 8, wherein the computer program further comprises a serialization option, which if enabled will increment the multimedia data file and insert a new file name variable along with a representation of a next multimedia data file for renaming the data file.

11. The data management system according to claim 8, wherein the computer program further comprises a collision option, which if enabled determines whether a current file name for a multimedia data file needs to be incremented or changed to avoid overwriting a preexisting file having the same name.

12. A multimedia management system for creating a multimedia presentation comprising:
a database of multimedia data files,
a user interface having representations of the multimedia data file;
a program of instructions to select multimedia data files from the database using the representations to create a list of multimedia data files,
a program of instructions to store the list of multimedia data files along with a set of instructions to play the list of multimedia data files on a display system.

13. The multimedia management system of claim 12, wherein the program of instructions to store the list of multimedia data files is designed to store the data files on a removable storage media.

14. The multimedia management system according to claim 13, wherein, the set of instructions to play the list of data files will automatically play the list of data files when the removable media is operatively connected to a playback system.

15. The multimedia management system according to claim 12, wherein the program of instructions to play the list of data files can specify playback of predetermined data files from the list.

16. The multimedia management system according to claim 12, wherein the program of instructions can specify multiple groups of predetermined data files for playback on a plurality of predetermined playback devices.

17. The multimedia management system according to claim 16, wherein the plurality of predetermined playback devices are selected from the group consisting essentially of televisions, high definition television (hdtv), a video display associated with a computer system, video monitors and video displays.

18. A system for managing multimedia data files comprising:
a database of multimedia data files in a computer readable memory,
a user interface having representations of the data files and a pointer to the data file in the computer readable memory, and
a program of instructions allowing the user to navigate through the database of multimedia data files using the representations of the multimedia data files in the user interface.

19. The system according to claim 18, wherein the computer readable memory is selected from the group consisting essentially of a memory device associated with a computer system, removable storage media or combinations thereof.

20. A system for managing multimedia data files comprising
a database of multimedia data files,
a user interface having representations of the data files, wherein multiple representations of a data file can be presented in the user interface, with any representation of a data file having a pointer to a single data file stored on computer readable memory.
